(19) United States
(12) Patent Application Publication
(10) Pub. No.: US 2026/0030269 A1
(43) Pub. Date: Jan. 29, 2026

(54) METHODS AND SYSTEMS FOR AUTOMATIC DETECTION AND FILLING OF INFORMATION GAPS IN A REFERENCE DATABASE

(71) Applicant: Shopify Inc., Ottawa (CA)

(72) Inventors: Benjamin Cox, Waterloo (CA); Robert Thornton, Ottawa (CA)

(21) Appl. No.: 18/781,304

(22) Filed: Jul. 23, 2024

(51) Int. Cl. G06F 16/332; G06F 16/33; G06F 40/40

(52) U.S. Cl. CPC G06F 16/3329; G06F 16/3344; G06F 16/3347; G06F 40/40

(57) ABSTRACT

Methods and systems for automatic detection and filling of information gaps in a reference database are described. Responsive to a user query in an ongoing chat session, a query embedding associated with the user query is obtained. A synthetic question embedding is identified from a vector database, based on a similarity to the query embedding. Responsive to determining that the similarity between the synthetic question embedding and the query embedding does not meet a similarity threshold, the ongoing chat session is monitored to detect an answer to the user query. A prompt is provided to a large language model (LLM) to generate and display a textual content corresponding to the user query, based on the detected answer, for automatically updating the reference database. The disclosed methods and systems effectively incorporate new or undocumented information that is not currently captured within the reference database, as gaps are identified.

### FIELD

The present disclosure relates to machine learning and large language models (LLMs), and, more particularly, to retrieval-augmented generation (RAG), and, yet more particularly, to the automatic detection and filling of information gaps in a reference database within a RAG framework.

### BACKGROUND

A large language model (LLM) is a type of machine learning (ML) model that can process natural language to summarize, translate, predict and generate text and other content. A LLM may be trained to learn billions of parameters in order to model how words relate to each other in a textual sequence. Inputs to an LLM may be referred to as prompts. A prompt is a natural language input that includes instructions to cause the LLM to generate a desired output, including natural language text or other generative output in various desired formats.

Retrieval Augmented Generation (RAG) is a process for optimizing the output of an LLM, by referencing a knowledge database (i.e., a database of documents that contain useful information) or other external sources that are outside the LLM training data sources, prior to generating a response.

A chatbot is a type of artificial intelligence that typically provides assistance to a user via a conversational interaction. Some chatbots make use of LLMs to carry out user interactions. Chatbots may also be referred to as virtual assistants, conversational agents or smart assistants.

### SUMMARY

Retrieval-augmented generation (RAG) is an AI framework used by search engines or LLM-based chatbots to improve the quality of responses. Rather than relying on the knowledge inherent to the LLM at the time it was trained, the LLM retrieves data from internal sources (e.g., a reference or knowledge database) and/or external sources (e.g., public data accessible via the internet) to improve the quality of response generation, for example, ensuring that the LLM is drawing from accurate and up-to-date information and enabling the LLM to provide a source.

Conventionally, virtual assistants (also referred to as chatbots) or existing search methods employing the RAG framework often have access to a database of stored documents and corresponding document embeddings (e.g., embeddings in a corpus embedding space), to assist in generating responses or returning search results. In response to a user input (e.g., a query or a search request), the virtual assistant or search engine may encode the user input into an input embedding and perform a vector similarity search to identify, based on similarity of the corresponding embeddings, one or more source texts (e.g., documents, articles, papers, webpages, text excerpts, passages, paragraphs or various other sub-document chunks containing textual content) that are deemed relevant to the user input. Identified document(s) may be retrieved from the database and used as additional input to the LLM to generate a response to the user input or may be returned in a set of search results.

This process assumes that the source texts being retrieved that are deemed relevant to the user input represent up-to-date sources of information. However, content can become stale or out-of-date and, in some cases, other sources may have access to information that is not yet reflected in the source texts, for example, a support agent or a support advisor (SA), such as a human support personnel or a human SA, may have access to internal sources of information or may possess knowledge (e.g., based on conversations, internal discussions, internal resources, personal experience etc.) that has not yet been distributed to the wider reference database. In customer support scenarios, particularly those utilizing automated systems for generating responses, an inherent delay exists between the emergence of new knowledge and its integration into the available reference database documentation (e.g., help articles). Updating reference database documentation is typically a slow and tedious manual process, and this delay results in LLM-based chatbots (or human SAs, for example, in a scenario where customer support is provided through a user interface by a human SA, but the LLM-based chatbot is generating responses that may assist the human SA) using outdated information to answer customer queries, potentially misleading the customer, or leading to a poor user experience. Furthermore, the challenge is exacerbated when updates need to be propagated across multiple documents or sub-document chunks in the database, each potentially requiring customized changes to reflect the updates accurately.

In various examples, the present disclosure provides a technical solution for implementing a chatbot application within a RAG-based framework that addresses at least some of the above drawbacks. In various examples, the present disclosure describes methods and systems for automatic detection and filling of information gaps in a reference database within a RAG framework, based on a support interaction. An information gap may be identified in a reference database when a vector similarity search performed for an embedding of a user query within a database of synthetic question embeddings returns candidate embeddings that do not meet a threshold similarity measure (e.g., threshold distance between embeddings), among other possibilities.

When an information gap in the reference database is identified, an LLM is prompted to update a corresponding portion of a source text (and/or to generate a corresponding new synthetic question embedding or question-answer (QA) pair), for inclusion in the reference database, based on a transcript of the support interaction. For example, a chat transcript of the support interaction between a SA and a user that sufficiently addresses the user query may include new or undocumented information that is not currently captured within the reference database. In this regard, the chat transcript may be provided to an LLM for automatically generating updated textual content for insertion into the reference database.

Examples of the disclosed solution may improve the performance of e-commerce platforms or merchant websites by presenting an improved help center or knowledge base experience to users. Continuous access to stale or incorrect information within a reference database may may result in a user inputting commands or performing actions that are invalid and/or that must be later undone, thus wasting computing resources and leading to user frustration. The disclosed solution enables more accurate and efficient generation of new or updated content for inclusion in the reference database, for assisting a future user or SA in solving a similar problem or answering a similar question. In this regard, new or updated information may be quickly incorporated into a reference database as gaps are identified, so that the information can be accessed by subsequent users as soon as possible. The method leverages the semantic understanding capabilities of the LLM to generate accurate and relevant updates to source text, using new information provided by trusted sources during the live support interaction.

Advantageously, rapidly propagating new or updated information through a reference database such that that the RAG-based engine continually has access to the most up-to-date information ensures that the LLM is provided with more relevant information to enable the LLM to generate appropriate output in fewer iterations (e.g., providing a relevant output the first time a user inputs a query, rather than requiring the user to try different phrasing of a query). In this regard, examples of the disclosed solution may reduce the unnecessary consumption of computing resources (e.g., processing power, memory, computing time, etc.) associated with performing multiple iterations of prompting to achieve a desired result from the LLM.

The rapid integration of new or updated information into the reference database further improves the accuracy and efficiency of document retrieval and response generation within a RAG-based framework. The disclosed solution may be automated, providing a real-time or “just-in-time” approach to updating the reference database. For example, collective institutional knowledge held by SAs, and particularly by senior or more experienced SAs may be efficiently captured as needed, and made available to less experienced SAs immediately, if a similar question is raised with another user. Incorporating automatic verification of new information based on user sentiment and/or customer action analysis (e.g., monitoring an event stream for changes to user accounts or for other actions taken by the user) makes efficient use of computational and other resources, avoiding lengthy delays associated with the manual review of chat transcripts by document writers after the fact.

In some examples, the present disclosure describes a computer-implemented method. The method includes a number of steps, including: responsive to a user query in an ongoing chat session, obtaining a query embedding based on the user query; searching a vector database to identify a synthetic question embedding in the vector database, the synthetic question embedding representing a synthetic question answerable using a corresponding source text, based on a similarity to the query embedding; responsive to determining that the similarity between the synthetic question embedding and the query embedding does not meet a similarity threshold, monitoring the ongoing chat session to detect an answer to the user query; generating, using a large language model (LLM), a textual content corresponding to the user query, based on the detected answer; and updating the corresponding source text or a different source text using the generated textual content.

In an example of the preceding example aspect of the method, wherein generating the textual content corresponding to the user query comprises: determining that the answer to the user query addresses the user query, the answer being provided by a source other than the user; generating a prompt to the LLM, the prompt including the user query and the answer to the user query; and providing the prompt to the LLM to generate the textual content.

In an example of the preceding example aspect of the method, further comprising: responsive to determining that the source providing the answer is a trusted source, inserting the generated textual content into the source text, the source text being stored in a reference database.

In an example of a preceding example aspect of the method, further comprising: monitoring an event stream of an account associated with the user; and responsive to determining that a change was made in the account based on the answer provided in the chat session, inserting the generated textual content into the source text.

In an example of a preceding example aspect of the method, further comprising: monitoring the chat session to identify a function associated with the answer provided in the chat session; monitoring an event stream of an account associated with the user; and responsive to determining that the function was called within a predetermined time, inserting the generated textual content into the source text.

In an example of a preceding example aspect of the method, wherein determining that the answer to the user query addresses the user query is based on an analysis of user sentiment during the chat session.

In an example of a preceding example aspect of the method, wherein updating the corresponding source text or the different source text using the generated textual content comprises: identifying the source text in a reference database for receiving the generated textual content; and replacing the source text with the generated textual content or appending the generated textual content to the source text.

In an example of the preceding example aspect of the method, wherein the source text points to a secondary document stored in the reference database, and replacing the source text with the generated textual content or appending the generated textual content to the source text comprises: replacing at least a portion of the secondary document with the generated textual content or appending the generated textual content to the secondary document.

In an example of a preceding example aspect of the method, wherein the embeddings database stores a plurality of embeddings defining an embedding space and wherein identifying the synthetic question embedding from the embeddings database comprises: performing a vector similarity search operation within the embedding space to identify the synthetic question embedding, based on similarity measures between embeddings of the plurality of synthetic question embeddings and the input embedding.

In an example of a preceding example aspect of the method, wherein the embeddings database stores a plurality of synthetic question embeddings associating the plurality of synthetic question embeddings to corresponding source texts, the method further comprising: generating a new synthetic question embedding based on the user query and the generated textual content; and updating the embeddings database to include the new synthetic question embedding.

In some examples, the present disclosure describes a computer system including: a processing unit configured to execute computer-readable instructions to cause the system to: responsive to a user query in an ongoing chat session, obtain a query embedding based on the user query; search a vector database to identify a synthetic question embedding in the vector database, the synthetic question embedding representing a synthetic question answerable using a corresponding source text, based on a similarity to the query embedding; responsive to determining that the similarity between the synthetic question embedding and the query embedding does not meet a similarity threshold, monitor the ongoing chat session to detect an answer to the user query; generate, using a large language model (LLM), a textual content corresponding to the user query, based on the detected answer; and update the corresponding source text or a different source text using the generated textual content.

In an example of the preceding example aspect of the system, wherein in generating the textual content corresponding to the user query, the processing unit is further configured to execute computer-readable instructions to cause the computer system to: determine that the answer to the user query addresses the user query, the answer being provided by a source other than the user; generate a prompt to the LLM, the prompt including the user query and the answer to the user query; and provide the prompt to the LLM to generate the textual content.

In an example of the preceding example aspect of the system, wherein the processing unit is further configured to execute computer-readable instructions to cause the computer system to: responsive to determining that the source providing the answer is a trusted source, insert the generated textual content into the source text, the source text being stored in a reference database.

In an example of a preceding example aspect of the system, wherein the processing unit is further configured to execute computer-readable instructions to cause the computer system to: monitor an event stream of an account associated with the user; and responsive to determining that a change was made in the account based on the answer provided in the chat session, insert the generated textual content into the source text.

In an example of a preceding example aspect of the system, wherein the processing unit is further configured to execute computer-readable instructions to cause the computer system to: monitor the chat session to identify a function associated with the answer provided in the chat session; monitor an event stream of an account associated with the user; and responsive to determining that the function was called within a predetermined time, insert the generated textual content into the source text.

In an example of a preceding example aspect of the system, wherein the processing unit is further configured to execute computer-readable instructions to cause the computer system to determine that the answer to the user query addresses the user query based on an analysis of user sentiment during the chat session.

In an example of a preceding example aspect of the system, wherein in updating the corresponding source text or the different source text using the generated textual content, the processing unit is further configured to execute computer-readable instructions to cause the computer system to: identify the source text in a reference database for receiving the generated textual content; and replace the source text with the generated textual content or appending the generated textual content to the source text.

In an example of the preceding example aspect of the system, wherein the source text points to a secondary document stored in the reference database, and in replacing the source text with the generated textual content or appending the generated textual content to the source text, the processing unit is further configured to execute computer-readable instructions to cause the computer system to: replace at least a portion of the secondary document with the generated textual content or appending the generated textual content to the secondary document.

In an example of a preceding example aspect of the system, wherein the embeddings database stores a plurality of embeddings defining an embedding space and wherein in identifying the synthetic question embedding from the embeddings database, the processing unit is further configured to execute computer-readable instructions to cause the computer system to: perform a vector similarity search operation within the embedding space to identify the synthetic question embedding, based on similarity measures between embeddings of the plurality of synthetic question embeddings and the input embedding.

In some examples, the present disclosure describes a non-transitory computer-readable medium storing instructions that, when executed by a processing unit of a computing system, cause the computing system to: responsive to a user query in an ongoing chat session, obtain a query embedding based on the user query; search a vector database to identify a synthetic question embedding in the vector database, the synthetic question embedding representing a synthetic question answerable using a corresponding source text, based on a similarity to the query embedding; responsive to determining that the similarity between the synthetic question embedding and the query embedding does not meet a similarity threshold, monitor the ongoing chat session to detect an answer to the user query; generate, using a large language model (LLM), a textual content corresponding to the user query, based on the detected answer; and update the corresponding source text or a different source text using the generated textual content.

In some examples, the computer-readable medium may store instructions that, when executed by the processor of the computing system, cause the computing system to perform any of the methods described above.

### BRIEF DESCRIPTION OF THE DRAWINGS

Reference will now be made, by way of example, to the accompanying drawings which show example embodiments of the present application, and in which:

FIG. 1A is a block diagram of a simplified convolutional neural network, which may be used in examples of the present disclosure;

FIG. 1B is a block diagram of a simplified transformer neural network, which may be used in examples of the present disclosure;

FIG. 2 is a block diagram of an example computing system, which may be used to implement examples of the present disclosure;

FIG. 3 is a block diagram illustrating an example chatbot application, in accordance with example embodiments of the present disclosure;

FIG. 4 is a block diagram illustrating an example RAG-based engine, in accordance with example embodiments of the present disclosure;

FIG. 5 is a block diagram illustrating an example system for updating information gaps in a reference database, in accordance with example embodiments of the present disclosure; and

FIG. 6 is a flowchart illustrating an example method for operation of an example chatbot application, in accordance with examples of the present disclosure.

Similar reference numerals may have been used in different figures to denote similar components.

### DETAILED DESCRIPTION

In various examples, methods and systems for the automatic detection and filling of information gaps in a reference database are described. Responsive to a user query in an ongoing chat session, a query embedding associated with the user query is obtained. A synthetic question embedding is identified from a vector database, based on a similarity to the query embedding. Responsive to determining that the similarity between the synthetic question embedding and the query embedding does not meet a similarity threshold, the ongoing chat session is monitored to detect an answer to the user query. A prompt is provided to a large language model (LLM) to generate and display a textual content corresponding to the user query, based on the detected answer, for automatically updating the reference database. The disclosed methods and systems effectively incorporate new or undocumented information that is not currently captured within the reference database, as gaps in the reference database are identified.

Examples of the disclosed solution enable the rapid incorporation of new or updated information within a reference database such that that the RAG-based engine continually has access to the most up-to-date information. This provides a technical advantage in that the LLM is provided with more relevant information to enable the LLM to generate appropriate output in fewer iterations (e.g., providing a relevant output the first time a user inputs a query, rather than requiring the user to try different phrasing of a query), thereby reducing the unnecessary consumption of computing resources (e.g., processing power, memory, computing time, etc.) associated with performing multiple iterations of prompting to achieve a desired result from the LLM.

Examples of the disclosed RAG-based engine may improve the performance of e-commerce platforms or merchant websites by presenting an improved help center or knowledge base experience to users. Examples of the disclosed technical solution leverage the semantic understanding capabilities of an LLM, using new information provided by trusted sources during a live support interaction to efficiently generate new or updated content for inclusion in the reference database, for assisting a future user or SA in solving a similar problem or answering a similar question.

As will be discussed further below, examples of the disclosed RAG-based engine may send prompts to and receive output from an LLM, which is a type of deep neural network.

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

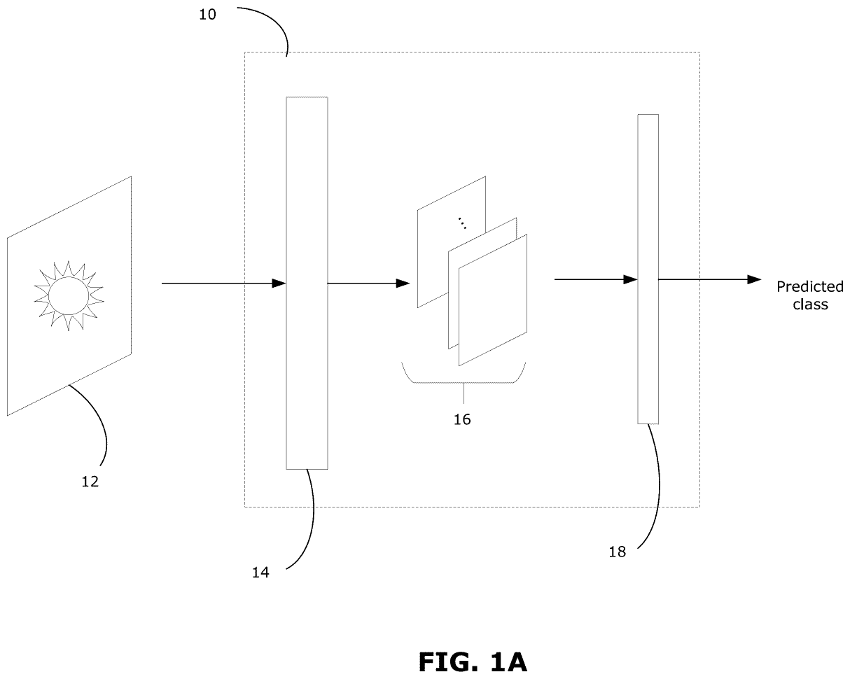

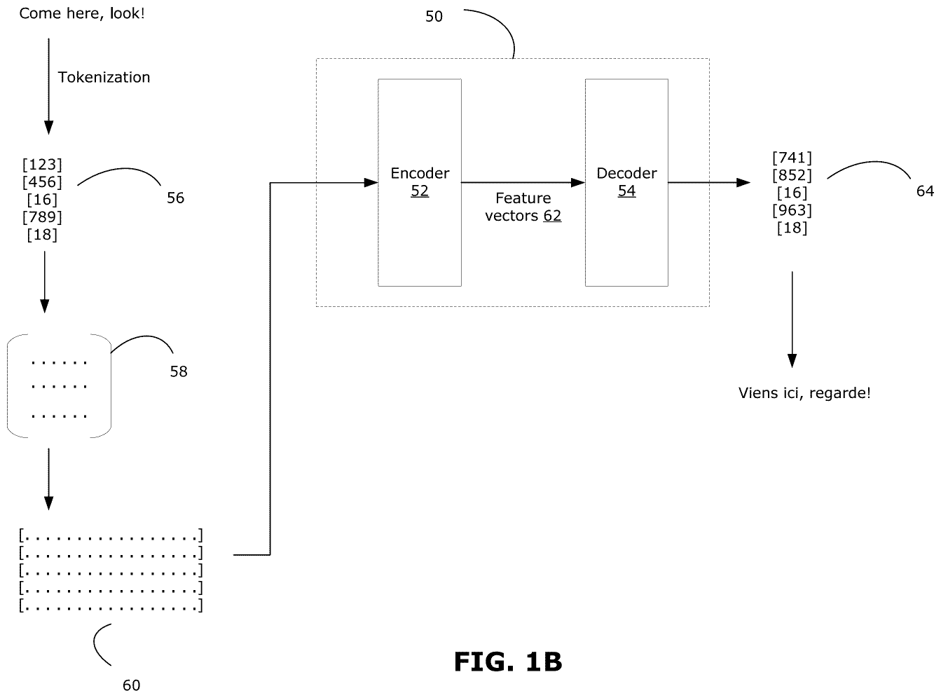

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labeled (e.g., annotated to indicate verbs, nouns, etc.) or unlabeled. LLMs may be trained on a large unlabeled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1B, a short sequence of tokens 56 corresponding to the text sequence “Come here, look!” is illustrated as input to the transformer 50. Tokenization of the text sequence into the tokens 56 may be performed by some preprocessing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space (or embedding space) may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

Although described above in the context of language tokens, embeddings and feature vectors are also commonly used to encode information about objects and their relationships with each other. For example, embeddings and feature vectors are frequently used in computer vision applications for object detection and semantic understanding. Embeddings that represent objects may be found in an embedding space, where the similarity and relationship of two objects (e.g., similarity between a cat and a lion) may be represented by the distance between the two corresponding embeddings in the embedding space.

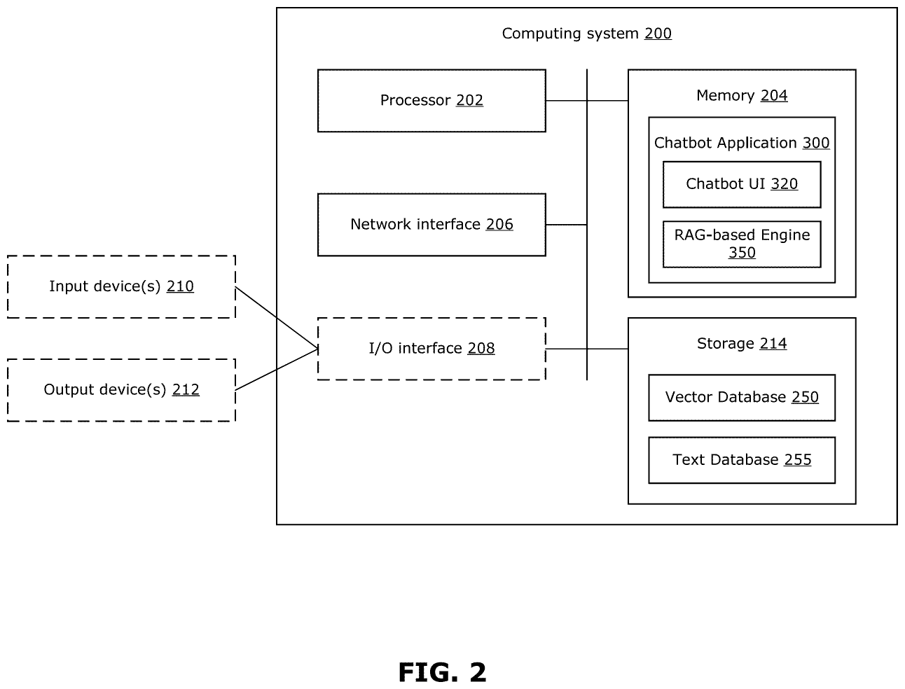

FIG. 2 illustrates an example computing system 200, which may be used to implement examples of the present disclosure. For example, the computing system 200 may be used to generate a prompt to an LLM to cause the LLM to generate output that includes text in a token-efficient language as disclosed herein. Additionally or alternatively, one or more instances of the example computing system 200 may be employed to execute the LLM. For example, a plurality of instances of the example computing system 200 may cooperate to provide output using an LLM in manners as discussed above.

The example computing system 200 includes at least one processing unit and at least one physical memory 204. The processing unit may be a hardware processor 202 (simply referred to as processor 202). The processor 202 may be, for example, a central processing unit (CPU), a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 204 may include a volatile or non-volatile memory (e.g., a flash memory, a random access memory (RAM), and/or a read-only memory (ROM)). The memory 204 may store instructions for execution by the processor 202, to the computing system 200 to carry out examples of the methods, functionalities, systems and modules disclosed herein.

The computing system 200 may also include at least one network interface 206 for wired and/or wireless communications with an external system and/or network (e.g., an intranet, the Internet, a P2P network, a WAN and/or a LAN). A network interface may enable the computing system 200 to carry out communications (e.g., wireless communications) with systems external to the computing system 200, such as a LLM residing on a remote system.

The computing system 200 may optionally include at least one input/output (I/O) interface 208, which may interface with optional input device(s) 210 and/or optional output device(s) 212. Input device(s) 210 may include, for example, buttons, a microphone, a touchscreen, a keyboard, etc. Output device(s) 212 may include, for example, a display, a speaker, etc. In this example, optional input device(s) 210 and optional output device(s) 212 are shown external to the computing system 200. In other examples, one or more of the input device(s) 210 and/or output device(s) 212 may be an internal component of the computing system 200.

A computing system, such as the computing system 200 of FIG. 2, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, in a message (e.g., in a payload of a message).

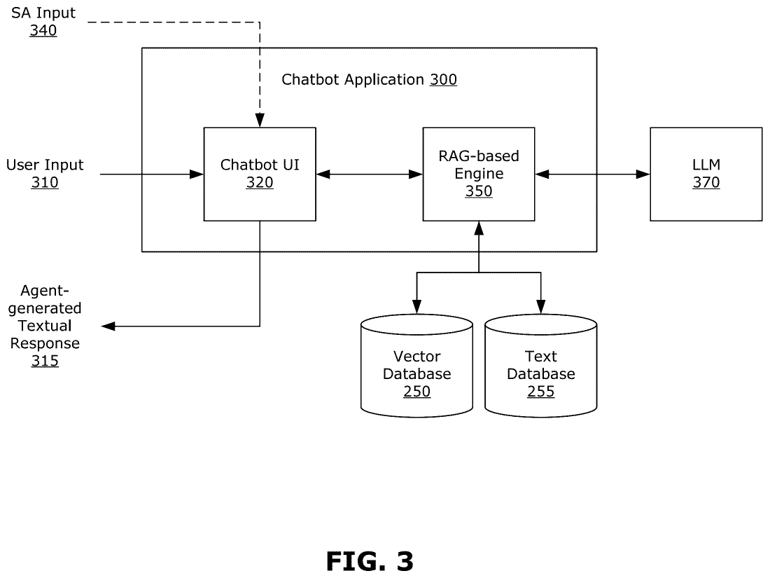

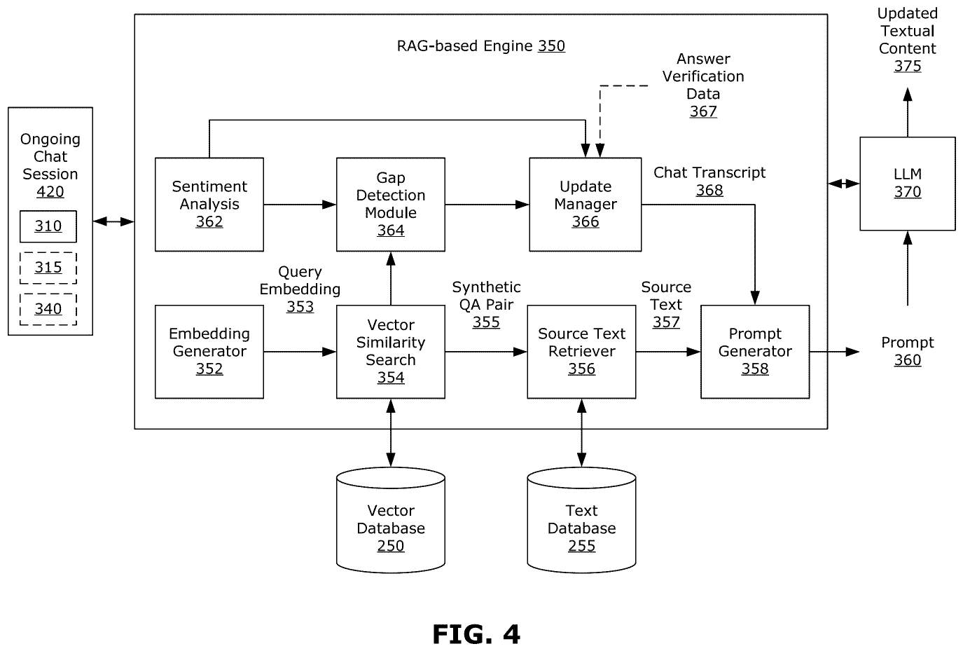

In the example of FIG. 2, the computing system 200 may store in the memory 204 computer-executable instructions, which may be executed by a processing unit such as the processor 202, to implement one or more embodiments disclosed herein. For example, the memory 204 may store instructions for running a chatbot application 300, including implementing a chatbot UI 320 and a RAG-based engine 350, for example, described with respect to FIG. 3 and FIG. 4 below.

In some examples, the computing system 200 may be a server of an online platform that provides the chatbot application 300 as a web-based or cloud-based service that may be accessible by a user device (e.g., via communications over a wireless network). Other such variations may be possible without departing from the subject matter of the present application.

The computing system 200 may also include a storage unit 214, which may include a mass storage unit such as a solid state drive, a hard disk drive, a magnetic disk drive and/or an optical disk drive. The storage unit 214 may store data, for example, a vector database 250 and a text database 255, among other data. In some examples, the storage unit 214 may serve as a database accessible by other components of the computing system 200. In some examples, the vector database 250 and/or the text database 255 may be external to the computing system 200, for example the computing system 200 may communicate with an external system to access the vector database 250 and/or the text database 255.

As will be discussed further below, the present disclosure describes an example chatbot application 300 that enables detection of information gaps in a reference database (e.g., text database 255) and prompts the LLM to generate suggested output for updating the reference database.

FIG. 3 shows a block diagram of an example architecture for the chatbot application 300, in accordance with examples of the present disclosure. The chatbot application 300 may be a software that is implemented in the computing system 200 of FIG. 2, in which the processor 202 is configured to execute instructions of the chatbot application 300 stored in the memory 204. In examples, the chatbot application 300 may be an LLM-based chatbot, for example, including a chatbot user interface (UI) 320 and a retrieval augmented generation (RAG)-based engine 350. The chatbot application 300 may receive a user input 310 (for example, a user query in the context of an ongoing chat session) and may generate a prompt for providing to a LLM 370 for generating a textual response to the user input 310 (e.g., as an agent-generated textual response 315). In some embodiments, for example, the ongoing chat session may be associated with a ticket, for example, a support ticket or another type of ticket, for identifying and/or tracking the ongoing chat session.

In examples, the user input 310 may be received by the chatbot application 300, for example, via the chatbot UI 320. In examples, the chatbot application 300 may be associated with a reference database search, among other applications. In examples, the user input 310 may be received as a textual input, for example, received via a textbox object in the chatbot UI 320 or in a chat window in the chatbot UI 320, among others. In other examples, the user input 310 may be an audio input, for example, received via a microphone of computing system 200, or the user input 310 may be received in another format, for example, as a touch input, or the user input 310 may be received as a selection of an item (e.g., a topic or category, or another object) on a webpage of an e-commerce platform, among other inputs.

In some embodiments, for example, the user input 310 may be phrased as a question (e.g., “how do I add a product to my online store?”) or the user input may not be phrased as a question. For example, a user input 310 may be phrased as a statement (e.g., “I'm trying to add a product to my online store”), a topic or category (e.g., “adding products to an online store”), or a keyword (e.g., “products”), or the user input may be phrased as a problem the user is experiencing (e.g., “I'm having trouble adding products to my online store”), among others. In some embodiments, for example, responsive to the user input 310, the chatbot application 300 may perform grammatical parsing of the user input 310 to determine whether the user input 310 is phrased in a question format, and in response to determining that the user input 310 is not phrased in a question format, the chatbot application 300 may cooperate with the LLM 370 to automatically generate a rephrased user input that reflects the user input 310 phrased in a question format, or that rephrases the user input 310 into a format that may enable more effective similarity matching with synthetic question embeddings (as discussed with respect to FIG. 4 below), regardless of whether or not the user input 310 is already phrased in a question format. In some examples, the chatbot application 300 may gather further information to clarify the user's intent, to request that the user rephrase the user input 310 in a question format, or to confirm that the rephrased user input reflects an accurate rephrasing of the user input 310, for example, where the user input 310 may be interpreted in more than one way (e.g., depending on whether the user is a merchant or whether the user is a customer). For example, a user input 310 of “where is my order button?” when posed by a merchant, may indicate that the merchant is looking for information on fulfilling orders within the administrator console, rather than a customer who may be seeking an order status. In examples, a user input 310 that is phrased in the form of a question or that has been rephrased by the chatbot application 300 to be phrased in the form of a question may represent a user query.

In some embodiments, for example, the chatbot application 300 may operate in an autonomous agent mode, where an ongoing chat session may be conducted between the user and the LLM-based chatbot (e.g., agent). For example, responsive to the user query, the agent-generated textual response 315 may be output to the user via the chatbot UI 320. In other embodiments, for example, the chatbot application 300 may operate in a live support interaction mode, where an ongoing chat session may be conducted between the user and a SA. In examples, the SA may be a technical support representative, a customer service representative, an expert or a professional (e.g., for providing professional services, such as counselling, tutoring, legal, health or other advice or assistance to the user in an online scenario), or any source other than the user. For example, responsive to the user query, the SA may interact with the user to address the user query by providing SA input 340 to the ongoing chat session via the chatbot UI 320. In examples, the SA input 340 may be received as a textual input, for example, received via a textbox object in the chatbot UI 320 or in a chat window in the chatbot UI 320, or the SA input 340 may be an audio input, among other possibilities. In other embodiments, for example, the chatbot application 300 may operate in an assistant mode, for example, where an ongoing chat session may be conducted between the user and the SA, but responsive to the user query, the LLM-based chatbot may output the agent-generated textual response 315 for viewing by the SA (e.g., to assist the SA in responding to the user query) via the chatbot UI 320.

In some embodiments, for example, the chatbot application 300 may transition from autonomous agent mode to live interaction mode or assistant mode. For example, a chat session event detected by the chatbot application 300 may indicate that the ongoing chat session requires intervention by another party, (e.g., a source other than the user) such as an SA. In some embodiments, for example, the ticket associated with the ongoing chat session may be escalated, and the SA may be provided with a summary of the ongoing chat session (e.g., user-agent chat summary) for providing context to the SA and enabling the SA to understand the nature of the user query prior to engaging with the user directly via the chatbot UI 320. For example, the LLM 370 may be prompted to generate the user-agent chat summary, based on a transcript of the ongoing chat session, among other possibilities.

FIG. 4 shows a block diagram of an example architecture for the RAG-based engine 350, in accordance with examples of the present disclosure. The RAG-based engine 350 may be a software that is implemented in the computing system 200 of FIG. 2, in which the processor 202 is configured to execute instructions of the RAG-based engine 350 stored in the memory 204. The RAG-based engine 350 includes an embedding generator 352, a vector similarity search operator 354, a source text retriever 356, a prompt generator 358, a sentiment analysis operator 362, a gap detection module 364 and an update manager 366. It should be understood that the modules 352, 354, 356, 358, 362, 364 and 366 are exemplary and not intended to be limiting. For example, the RAG-based engine 350 may include a greater or fewer number of modules than that shown. As well, operations described as being performed by a particular module may be additionally or alternatively performed by another subsystem.

In examples, responsive to a user query received during an ongoing chat session 420, the embedding generator 330 may obtain a query embedding 353 based on the user query. In the present disclosure, “embeddings” can refer to learned representations of discrete variables as vectors of numeric values, where the “dimension” of the embedding corresponds to the length of the vector (i.e., each entry in the embedding is a numeric value in a respective dimension represented by the embedding). In some examples, embeddings may be referred to as embedding vectors. In examples, embeddings may represent a mapping between discrete variables and a vector of continuous numbers that effectively capture meaning and/or relationships in the data. In examples, embeddings may be represented as points in a multidimensional space (which may be referred to as the embedding space), where embeddings exhibiting similarity are clustered closer together. In examples, embeddings may be learned for neural network models.

In examples, the embedding generator 352 may apply an embedding transformation to the user query to obtain the query embedding 353. In examples, the embedding generator 352 may apply the transformation using a neural network model. In some embodiments, for example, the embedding generator 352 may be an encoder. In examples, the embedding generator 352 may encode the user query into a respective embedding vector within an embedding space, to generate the query embedding 353.

In examples, the vector similarity search operator 354 may receive the query embedding 353 and may identify a relevant synthetic question embedding representing a synthetic question answerable using a corresponding source text 357, based on a similarity to the query embedding 353. Each synthetic question may be arranged as a synthetic question-answer (QA) pair that is mapped to a portion of a document (e.g., a chunk, or a citation) in a corpus (e.g., where the document is a source text and the corpus is the collection of source texts in the reference database), where an answer to the synthetic question may be reliably obtained from the document. In examples, the vector database 250 may store the plurality of synthetic question embeddings defining an embedding space, where each of the plurality of synthetic question embeddings is mapped to a corresponding source text 357 stored in the text database 255. In examples, the text database 255 may represent an internal database, for example, a reference database or another internal database containing a plurality of documents or other content sources, such as reports, research papers, product specifications, presentations, manuals, guides, training material, transcripts, etc. In examples, a source text 357 may represent a document chunk, for example, a portion of a document or other content source (e.g., separated based on headings, etc.) that is stored in the text database 255.

In examples, the vector similarity search operator 354 may search the embedding space defined by the plurality of synthetic question embeddings to identify the one or more relevant synthetic QA pairs 355, based on a similarity measure. In examples, a nearest neighbor approach may be used to identify the one or more synthetic QA pair 355. In examples, the similarity measure may be a distance measure (e.g., a Euclidean distance measured between the query embedding 353 and the synthetic QA pair 355 in any direction within the embedding space), or the similarity measure may be a cosine similarity (e.g., a cosine of the angle between the query embedding 353 and the synthetic QA pair 355), among other possibilities. In some examples, the identified QA pair 355 may be ranked, for example, taking into account a context of a user's current page, or recent viewing or search history, the identity or user type (e.g., merchant, customer etc.) of the user, among other user information, or using the Boolean model of information retrieval. In examples, a vector similarity score may be generated for each of the plurality of synthetic QA pairs 355 in the vector database 250, based on the similarity measure or additionally, based on the ranking or based on a similarity threshold, among other possibilities.

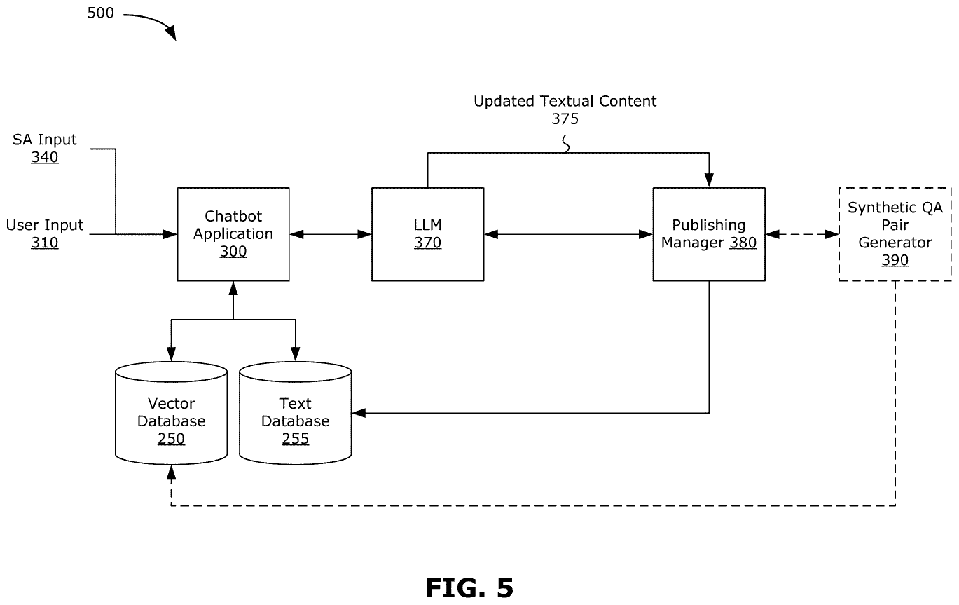

In examples, prior to identifying the relevant synthetic QA pair 355, a plurality of synthetic QA pairs may first be generated and stored in the vector database 250. In examples, synthetic QA pairs may be generated as described below, for example, using a synthetic QA pair generator 390 (as shown in FIG. 5), or the generation of synthetic QA pairs may be a function of the chatbot application 300, among other possibilities. The term “synthetic question” may be used to refer to a question (e.g., having a corresponding answer) that is generated by the LLM 370 independent of a user query. In other words, a synthetic question should be understood to be distinct from a user query. For example, the prompt generator 358 may provide a prompt to the LLM 370 instructing the LLM 370 to generate a set of synthetic questions (and corresponding answers), based on a source text 357 stored in the text database 255. For example, a prompt may be provided to the LLM 370 that provides context to the LLM 370 (e.g., the prompt may indicate that the LLM 370 is a support AI chatbot and that the LLM 370 is trying to answer user questions). The prompt may, after providing a specific source text 357, instruct the LLM 370 to generate possible questions that have answers that could be found in the source text 357. For example, the prompt generator 358 may obtain one or more source texts 357 and insert instructions to the LLM 370 to generate the following example prompt (example 1):
You are exceptionally skilled at extracting question and answer cards from the supplied help texts. The question and answer cards that you create must only be created from content that is found in the help texts provided. If there is a set of instructions provided by the help texts return all of the information defined in those instructions.
You MUST respond in this format for each card:
[CARD]
Question: <Required: Question that you anticipate a user might ask>
Answer: <Required: The detailed answer that you inferred from the provided message>
[/CARD].
The next message is the help content, it's related to topic “#{node}”
Generate as many cards as you can. End your message by saying MORE if you have more useful cards in you or say NEXT to get a new document.

The example prompt of example 1 may be considered to have several main parts. First, there are instructions to the LLM 370 that provide instructions to generate a plurality of paired synthetic questions and answers (e.g., associated with a respective card) based on content provided in a help text (e.g., source text 357). This is followed by a separator (in this case, multiple asterisks) and then the format of the question and answer for each card is identified. This is followed by another separator and then further instructions for generating a plurality of cards for a given source text 357 (e.g., indicating both the source document and the specific chunk or position within the document) before moving on to repeat the process with a new source text 357.

In examples, a synthetic question associated with a synthetic QA pair 355 may represent a specific question that can be answered based on the source text 357, and not simply a summary of the source text 357. In examples, each synthetic QA pair 355 may include a mapping to a corresponding source text 357 (e.g., a tag that indicates the source text 357), for example, where the mapping includes information identifying the source document from which it was generated, and optionally, the specific portion of the source documents from which the associated synthetic question was produced. In other examples, each synthetic QA pair 355 may include a tag that indicates whether the question would be posed by a merchant or a customer, among others. In examples, since more than one synthetic question may be generated from each source text 357, it is understood that more than one synthetic QA pair 355 may be mapped to the same source text 357. In this regard, examples of the present disclosure leverage the semantic understanding capabilities of the LLM 370 to formulate more accurate and relevant synthetic questions, thereby improving the accuracy of document retrieval and response generation. In examples, each paired synthetic question and answer (e.g., associated with a respective card) may be encoded by the embedding generator 352 (e.g., transformed into a respective embedding vector within an embedding space), to generate the plurality of synthetic QA pairs 355, and stored in the vector database 250.

Returning to FIG. 4, the source text retriever 356 may receive the identified synthetic QA pair 355 and may query the text database 255 to obtain a corresponding source text 357, based on the stored mapping between the synthetic QA pair 355 and the source text 357. In examples, the source text 357 may then be provided to the prompt generator 358, for generating a prompt 360 to the LLM 370 (such as GPT-3, or an aggregation of multiple LLMs or other models), where the prompt 360 instructs the LLM 370 (or multiple LLMs or other models) to generate a textual response to the user query. In examples, the LLM 370 may be prompted to parse the relevant section of the identified source text 357 and to output an answer to the user query, for example, as agent-generated textual response 315.

In examples, the agent-generated textual response 315 may be provided for display via a user device. For example, the LLM 370 may be configured to cooperate with the chatbot UI 320 for displaying the agent-generated textual response 315 on a display of a user device (e.g., the agent-generated textual response 315 from the LLM 370 may be provided to the chatbot application 300, to enable the agent-generated textual response 315 to be presented via the chatbot UI 320). In some embodiments, for example, the chatbot application 300 may be associated with a web-based reference database or help center, and the agent-generated textual response 315 may be displayed on a webpage of the reference database or help center. In other embodiments, for example, the chatbot application 300 may represent a support AI chatbot, and the agent-generated textual response 315 may be displayed in a chat window.

When a similarity score is sufficiently low to suggest that a good match does not exist between the query embedding and the set of synthetic question embeddings, an information gap in the reference database may be identified. For example, a low similarity score may indicate that the user query is considered to be a new question that is not reflected in the vector database 250 of synthetic question embeddings. In examples, the gap detection module 364 may receive information from the vector similarity search operator 354 corresponding to similarity scores and may compare the received similarity scores to a similarity threshold, for example, for determining that an information gap exists in the reference database. In examples, responsive to determining that the similarity between the synthetic question embedding and the query embedding does not meet a similarity threshold, the gap detection module 364 may monitor the ongoing chat session 420 (e.g., monitor a transcript of the support interaction using sentiment analysis 362 or other natural language processing techniques) to detect an answer to the user query. For example, the ongoing chat session 420 may represent an interaction between the user and SA, and the SA may access or consult other internal sources of information (e.g., internal databases, discussions with colleagues, personal knowledge of the SA, etc.) to address the user query. In this regard, new or updated information may be organically compiled and captured during the ongoing chat session 420 that answers a particular user query that was previously unanswerable using the information contained in the reference database. In examples, in detecting the answer to the user query, the gap detection module 364 may monitor the user's reaction to the information provided by the SA in response to the user query, for example, using sentiment analysis or other NLP techniques. In examples, detecting a positive sentiment of the user may indicate that the information provided by the SA in response to the user query is valid information that successfully answers the user query.

In some embodiments, for example, the chatbot application 300 may track a user satisfaction with respect to the agent-generated textual response 315. In examples, the sentiment analysis operator 362 may perform sentiment analysis for the user input 310 during the ongoing chat session 420 to determine whether the agent-generated textual response 315 addresses the user query. In other examples, direct feedback from the user may be requested, for example, by prompting the LLM 370 to generate a question for providing to the user via the chatbot UI 320, such as “are you satisfied with this answer”? or “did that response and/or document answer your question?”. In this regard, a poor user satisfaction associated with an agent-generated textual response 315 may indicate the existence of an information gap in the reference database. For example, when a synthetic QA pair 355 having a similarity score that is sufficiently high (e.g., above a similarity threshold) to suggest that a good match does exist with the query embedding is used for generating an agent-generated textual response 315 that is not satisfactory to the user (e.g., as determined using sentiment analysis or other NLP techniques), the synthetic QA pair 355 (and corresponding source text 357) may be considered to be insufficient and may require updating. For example, the corresponding source text 357 may be associated with out-of-date, incorrect or insufficient information stored in the text database 255, rendering it unable to effectively answer the user query. In this regard, the gap detection module 364 may monitor the ongoing chat session 420, for example, using natural language processing and/or sentiment analysis 362 for determining that an information gap exists in the reference database.

In some embodiments, for example, when an agent-generated textual response 315 is deemed insufficient to answer the user query (e.g., as determined by sentiment analysis or user feedback, among other possibilities), the ongoing chat session 420 may be transferred to a SA. In examples, the SA may be a human SA or any source other than the user. For example, the ticket associated with the ongoing chat session 420 may be escalated, and the chatbot application 300 may transition from operating in autonomous agent mode, to operating in a live support interaction mode (e.g., where the ongoing chat session 420 may be conducted between the user and the SA) or in an assistant mode (e.g., where the ongoing chat session 420 may be conducted between the user and the SA but the agent-generated response 315 is visible to the SA for assisting the SA in interacting with the user). In some embodiments, for example, responsive to detecting a poor user satisfaction associated with the agent-generated textual response 315, the gap detection module 364 may determine that that an information gap exists in the reference database that requires updating. In examples, the gap detection module 364 may monitor the ongoing chat session 420 (e.g., monitor a transcript of the ongoing chat session 420 using sentiment analysis 362 or other natural language processing techniques) to detect an answer to the user query, where the answer to the query is provided by a source other than the user. For example, while interacting with the user during the ongoing chat session 420, the SA may access or consult other internal sources of information (e.g., internal databases, discussions with colleagues, personal knowledge of the SA, etc.) to address the user query. In this regard, new or updated information may be organically compiled and captured within the ongoing chat session 420 that answers a particular user query that was previously unanswerable using the information contained in the reference database.

In some embodiments, for example, while monitoring the ongoing chat session 420, the gap detection module 364 may detect that an answer provided by the SA is significantly different from the agent-generated textual response 315, or the gap detection module 364 may detect that an embedding encoded from a chat session QA pair (e.g., the user query and the detected answer provided by the SA) is not sufficiently similar to the synthetic QA pair 355 embedding. In this regard, the gap detection module 364 may determine that an information gap exists in the reference database.

In some embodiments, for example, the chatbot application 300 may track a user satisfaction with respect to the detected answer, for example, the sentiment analysis operator 362 may perform sentiment analysis on user input 310 during the ongoing chat session 420 to determine that the answer to the user query addresses the user query, or direct feedback from the user may be requested, for example, by prompting the LLM 370 to generate a question for providing to the user via the chatbot UI 320, such as “are you satisfied with this answer”? or “did that response and/or document answer your question?”.

In examples, responsive to determining that an information gap exists in the reference database, and that the detected answer addresses the user query, the update manager 366 may receive answer verification data 367 for verifying the detected answer. For example, answer verification data 367 may include information for evaluating a trust level of the source of the answer (e.g., the SA), to determine whether the source providing the answer is a trusted source. For example, answer verification data 367 may include metadata corresponding to the SA or the account of the SA, such as SA seniority, SA user satisfaction ranking (e.g., based on user satisfaction scores associated with answers generated by the SA in previous user interactions), total logged hours of support interactions by the SA, number of articles authored by the SA, number of support tickets the SA has previously contributed to, etc. In this regard, answer verification data 367 may indicate that the answer is a verified answer because the source is a trusted source. Advantageously, determining whether the source providing the answer is a trusted source before generating the textual content may improve the efficiency of the LLM-based chatbot, for example, by avoiding unnecessary prompting of the LLM 370 and minimizing resources associated with response generation by the LLM 370 (e.g., computing resources, tokens, etc.).

In examples, answer verification data 367 may include event stream data for the user. For example, the update manager 366 may monitor an event stream of an account associated with the user (e.g., for a pre-determined period of time following the support interaction) to determine whether the detected answer is valid and/or whether the answer should be integrated into the reference database. For example, event stream data may present evidence that specific actions were carried out or changes were made to account settings in response to the detected answer (e.g., using new information provided to the user in the answer), may validate the detected answer as reliable information that should be integrated into the reference database. In examples, answer verification data 367 may include information for detecting that a change was made in the user account (e.g., within the administrator settings, among other possibilities) based on the answer to the user query provided in the chat session 420. In this regard, the update manager 366 may verify the detected answer according to detected changes to a user account. In other examples, the update manager 366 may monitor the ongoing chat session 420 to identify a function associated with the answer provided in the chat session, and answer verification data 367 may include information for determining (e.g., from the monitored event stream of an account associated with the user) that the function was called within a predetermined time. For example, the LLM 370 may be prompted to analyze a portion of the ongoing chat session transcript to identify related function, and the answer verification data 367 may indicate whether the function was carried out within a pre-determined time. In this regard, the update manager 366 may verify the detected answer according to the calling of one or more functions.

In examples, responsive to verifying the answer to the user query, a transcript of the ongoing chat session 420 (e.g., the chat transcript 368, for example, including at least the user query and the detected answer) may then be provided to the prompt generator 358 for generating a prompt 360 to the LLM 370 (such as GPT-3, or an aggregation of multiple LLMs or other models), where the prompt 360 instructs the LLM 370 (or multiple LLMs or other models) to generate a textual response, for example, as updated textual content 375. In examples, the LLM 370 may be prompted to parse the relevant section of the chat transcript 368 to generate the updated textual content 375, where the updated textual content 375 represents a suggested update to an existing source text 357, or the updated textual content 375 may represent a new source text for storage in the reference database.

For example, the prompt generator 358 may generate the following prompt (example 2) to instruct the LLM 370 to generate an updated textual content 375 as a “corrected help text”:
You are given two pieces of text: “help text” and “answer text”. The “help text” contains the original content that may have errors or missing information. The “answer text” contains the correct or updated information. Your task is to integrate the “answer text” into the “help text” to produce a corrected version of the “help text”. Ensure that the final “corrected help text” is coherent and accurately reflects the updates provided in the “answer text”, as shown in the example below:
Help Text: The quick brown fox hops under the lazy dog.
Answer Text: The fox jumps over the dog.
Corrected Help Text: The quick brown fox jumps over the lazy dog.

The example prompt of example 2 includes instructions to the LLM 370 to generate a “corrected help text” according to the provided example, using a provided “help text” (e.g., a given source text 357) and a provided “answer text” (e.g., the chat transcript 368 or the parsed relevant section of the chat transcript 368).

FIG. 5 shows a block diagram of a system 500 for updating information gaps in a reference database, in accordance with examples of the present disclosure. The system may include the chatbot application 300, the LLM 370, a publishing manager 380 and optionally, a synthetic QA pair generator 390. It should be understood that the modules 300, 370, 380, and 390 are exemplary and not intended to be limiting. For example, the system 500 may include a greater or fewer number of modules than that shown. As well, operations described as being performed by a particular module may be additionally or alternatively performed by another subsystem. For example, operations performed by the synthetic QA pair generator 390 may be performed by the chatbot application 300 in cooperation with the LLM 370. In examples, the system 500 may update the existing reference database documentation (e.g., by replacing a portion of a corresponding source text 357 or a different source text, for example, stored in text database 255) or may append the updated textual content 375 to existing reference database documentation, or the system 500 may insert a new source text into the reference database documentation (e.g., text database 255).

In examples, the updated textual content 375 may be provided to a publishing queue for review, prior to being incorporated into the reference database documentation, where the publishing queue is managed by the publishing manager 380. For example, updated textual content 375 may be provided to the publishing manager 380 as proposed edits to document, and may require a confirmation or approval of the proposed edits before updating or appending the reference database, or the updated textual content 375 may be provided to the publishing manager 380 in another format. In examples, the publishing manager 380 may identify a recipient source text (e.g., a candidate document) for inserting the updated textual content 375. The candidate document may be identified based on an existing mapping between a synthetic question embedding (e.g., synthetic QA pair 355) and a source text 357 or based on category and topic identification, among other possibilities. In other examples, the candidate document may be identified based on a similarity between the updated textual content 375 and other documents in the reference database (e.g., representing duplicates of the information). For example, the vector database 250 may store a plurality of text embeddings defining an embedding space, where each of the plurality of text embeddings is mapped to a corresponding source text 357 stored in the text database 255, and the vector similarity search operator 354 may search the embedding space defined by the plurality of text embeddings to identify one or more relevant recipient source texts, based on a similarity measure. In examples, if no close matches exist between the updated textual content 375 and existing source texts in the reference database, a new source text may be initiated.

In examples, responsive to identifying the candidate document, the publishing manager 380 may locate an appropriate portion (e.g., a chunk or section) of the candidate document for replacing or appending, for example, with the updated textual content 375. Alternatively, a portion of the candidate document may point to another source, such as a secondary document, for example, stored in the reference database. In examples, the secondary document may contain reference text (e.g., a “partial”) that may be used in multiple documents. In examples, the publishing manager 380 may locate the secondary document for replacing or appending, for example, with the updated textual content 375. In some examples, the publishing manager 380 may use citations to identify specific sentences to change within a document chunk.

In examples, the publishing manager 380 may cooperate with the LLM 370 for integrating the updated textual content 375 into the candidate document (or the partial) by updating, replacing portions of, or rewriting the candidate document (or the partial) to include the updated textual content 375, or by appending the updated textual content 375 to the existing text in the candidate document or the partial, for example, ensuring semantic consistency. In examples, the publishing manager 380 may instruct the LLM 370 to follow a certain style guide, or to restrict updates to only certain document chunks corresponding to a particular synthetic QA pair 355 or source text 357, or alternatively the publishing manager 380 may instruct the LLM 370 to not change certain sections of the candidate document. In examples, the publishing manager 380 may include a publishing queue, where any proposed updates to the reference database may require a confirmation or approval before being implemented in the reference database. In examples, confirmation or approval of proposed updates to the reference database may depend on confirmation that the source providing the answer during the chat session 420 was a trusted source, or that the answer was verified (e.g., a change was made in the account based on the answer provided in the chat session 420, or a function was called within a predetermined time), among other possibilities.

In some embodiments, for example, responsive to updating the reference database using the updated textual content 375, one or more new synthetic question embeddings (e.g., new synthetic QA pairs) may be generated by the synthetic QA pair generator 390 for inclusion in the vector database 250. For example, the synthetic QA pair generator 390 is shown as a separate block, however it is understood that operations of the synthetic QA pair generator 390 may be performed by other modules, such as the chatbot application 300. In examples, a prompt generator (e.g., prompt generator 358 or another prompt generator associated with synthetic QA pair generator 390) may provide a prompt to the LLM 370 instructing the LLM 370 to generate a set of synthetic questions (and corresponding answers), based on the user query and the updated textual content 375. In examples, the prompt may follow a form that is consistent with the prompt provided in example 1. In examples, each new synthetic QA pair may include a mapping to the updated textual content 375, for example, where the mapping includes information identifying the updated textual content 375 as the source document from which the new synthetic QA pair was generated, and optionally, the specific portion of the updated textual content 375 from which the associated new synthetic question was produced. In examples, each new synthetic QA pair may be encoded (e.g., transformed into a respective embedding vector within an embedding space by the embedding generator 352 or another encoder associated with the synthetic QA pair generator 390), to generate the one or more new synthetic QA pairs. In examples, the vector database 250 may be updated to include the one or more new synthetic QA pairs.

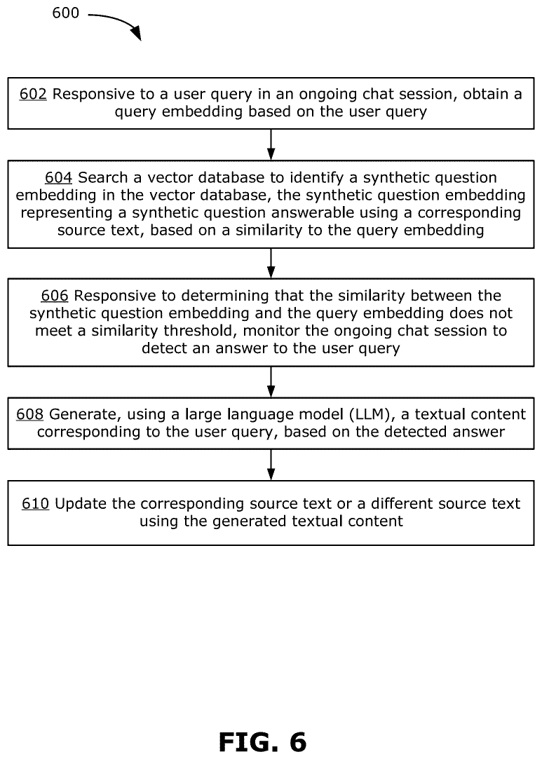

FIG. 6 is a flowchart of an example method 600 for operation of an example chatbot application 300, in accordance with examples of the present disclosure. The method 600 may be performed by the computing system 200. For example, a processing unit of a computing system (e.g., the processor 202 of the computing system 200 of FIG. 2) may execute instructions (e.g., instructions of the chatbot application 300) to cause the computing system to carry out the example method 600. The method 600 may, for example, be implemented by an online platform or a server.

At an operation 602, responsive to a user query (e.g., included within user input 310) in an ongoing chat session 420, a query embedding 353 may be obtained. In examples, an embedding transformation may be applied to the user query to generate the query embedding 353, for example, the embedding transformation may transform the user query into a respective embedding vector within an embedding space. In examples, the embedding transformation may be applied using a neural network model. In examples, the user input 310 may be received as a textual input, an audio input, a touch input, as a selection of an item (e.g., a topic or category, or another object) on a webpage, such as a webpage of an e-commerce platform, among other inputs.

At an operation 604, a vector database 250 may be searched and a synthetic question embedding representing a synthetic question answerable using a corresponding source text (e.g., synthetic QA pair 355) may be identified from the vector database 250, based on a similarity to the query embedding 353. In examples, a vector similarity search operation may be performed to identify one or more synthetic QA pairs 355 from the vector database 250. In examples, a nearest neighbor approach may be used to identify the one or more synthetic QA pairs 355.

At an operation 606, responsive to determining that the similarity between the synthetic question embedding and the query embedding does not meet a similarity threshold, the ongoing chat session 420 may be monitored to detect an answer to the user query. For example, the gap detection module 364 may monitor the chat transcript 368 of an interaction between the user and a SA during the ongoing chat session 420 using sentiment analysis 362 or other natural language processing techniques, to detect an answer to the user query. In examples, the SA may access or consult other internal sources of information (e.g., internal databases, discussions with colleagues, personal knowledge of the SA, etc.) to address the user query, thereby organically compiling and capturing new or updated information related to the user query, within the chat transcript 368. In examples, the gap detection module 364 may monitor the user's reaction to the information provided by the SA during the ongoing chat session, where detecting a positive sentiment of the user may indicate that the information provided by the SA (and captured in the chat transcript 368) during the ongoing chat session 420 represents a valid and/or acceptable answer to the user query.

At an operation 608, an updated textual content 375 corresponding to the user query may be generated, using an LLM 370, based on the detected answer. For example, a prompt 360 may be generated for the LLM 370, where the prompt 360 instructs the LLM 370 to generate the updated textual content 375 corresponding to the user query, based on the information captured in the chat transcript 368. In examples, the LLM 370 may be prompted to parse the chat transcript 368 to output an answer to the user query.

At an operation 610, the corresponding source text 357 or a different source text associated with the reference database (e.g., stored in the text database 255) may be updated, using the updated textual content 375. For example, the source text for receiving the generated textual content may be identified in the reference database based on a vector similarity search operation, for example, for identifying one or more recipient source texts (e.g., documents, articles, papers, webpages, text excerpts, passages, paragraphs or various other sub-document chunks containing textual content) that are related or deemed relevant to the generated textual content 375. In some embodiments, for example, the recipient source text may be the corresponding source text of step 604, or the vector similarity search operator 354 may search the embedding space defined by the plurality of synthetic question embeddings to identify other one or more recipient source texts associated with (e.g., mapped to) one or more relevant synthetic QA pairs 355, based on a similarity measure. In other embodiments, for example, the vector database 250 may also store a plurality of text embeddings defining an embedding space, where each of the plurality of text embeddings is mapped to a corresponding source text 357 stored in the text database 255, and the vector similarity search operator 354 may search the embedding space defined by the plurality of text embeddings to identify one or more relevant recipient source texts, based on a similarity measure. For example, a plurality of candidate recipient source texts (e.g., candidate documents or document chunks, etc.) may be identified as containing text that may require updating and may be evaluated to determine which of the plurality of candidate recipient source texts are the best source text(s) to update. For example, the evaluation may be based on a similarity measure, or some other means of identifying the best source text(s) to update.

Responsive to identifying the recipient source text for receiving the generated textual content, the recipient source text or a portion of the recipient source text may be replaced with the generated textual content 375, or the generated textual content may be appended to the recipient source text. In some examples, the recipient source text may point to a secondary document stored in the reference database, and replacing the source text with the generated textual content or appending the generated textual content to the source text comprises replacing at least a portion of the secondary document with the generated textual content or appending the generated textual content to the secondary document.

Examples of the present disclosure may enable more accurate response generation by a LLM, for example, by ensuring that the LLM continually has access to the most relevant information (e.g., in a reference database) for use by the LLM in generating responses. A RAG-based engine as disclosed herein may be used in various implementations, such as on a website, a portal, a software application, etc. In an example, the disclosed RAG-based engine may be implemented on an e-commerce platform, for example to assist a user (e.g., a merchant, store owner or store employee) in providing answers to specific questions related to operation of the e-commerce platform, for example, performing tasks on an administrative webpage or portal of an online store.

For example, the chatbot application and RAG-based engine as disclosed herein may be provided as an engine of the e-commerce platform. A user may interact with the e-commerce platform via a user device (e.g., a merchant device or a customer device, generally referred to as a user device) to provide user input and receive a textual response and/or initiate updates to a reference database as described above.

In various examples, the present disclosure provides a technical solution that enables more accurate and more efficient operation of a RAG-based engine by rapidly incorporating new or updated information within a reference database as information gaps are identified, ensuring the retrieval of more accurate source information, for use by an LLM in generating a response to a user input. The use of chat transcripts of support interactions with trusted advisors is an efficient mechanism for continually incorporating new or updated information into a reference database, which enables the LLM to generate a more accurate response. Providing the LLM with more relevant information may cause the LLM to generate an appropriate output in fewer iterations, thereby reducing the unnecessary consumption of computing resources (e.g., processing power, memory, computing time, etc.) associated with performing multiple iterations of prompting to achieve a desired result from the LLM. Examples of the disclosed RAG-based engine may improve the performance of e-commerce platforms or merchant websites by presenting an improved help center or knowledge base experience to users. Examples of the disclosed technical solution leverage the semantic understanding capabilities of an LLM to efficiently generate new or updated content for inclusion in the reference database, for assisting a future user or SA in solving a similar problem or answering a similar question.

Although the present disclosure has described a LLM in various examples, it should be understood that the LLM may be any suitable language model (e.g., including LLMs such as LLaMA, Falcon 40B, GPT-3, GPT-4 or ChatGPT, as well as other language models such as BART, among others).

Although the present disclosure describes methods and processes with operations (e.g., steps) in a certain order, one or more operations of the methods and processes may be omitted or altered as appropriate. One or more operations may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer-implemented method comprising:
responsive to receiving, by a computing device, a user query in an ongoing chat session, obtaining a source text from a reference database for augmenting a large language model (LLM) in generating a response that answers the user query, by searching a vector database to identify a synthetic question embedding, based on a similarity between the synthetic question embedding and an embedding representation of the user query, wherein the synthetic question embedding represents a synthetic question that is answerable using a corresponding source text and wherein a relevance of the identified synthetic question embedding is based on a similarity threshold;
responsive to determining that the searching does not return a relevant synthetic question embedding that meets the similarity threshold, monitoring the ongoing chat session to detect an answer to the user query in a transcript of the chat session;
generating a prompt to the LLM for generating a textual content for inclusion in the reference database, the prompt including the user query and the transcript;
providing the prompt to the LLM to cause the LLM to generate the textual content; and
automatically updating the corresponding source text or a different source text using the generated textual content.

2. The method of claim 1, wherein
the answer is provided by a human source other than a user.

3. The method of claim 2, further comprising:
responsive to determining that the human source that provided the answer in the chat session is a trusted source, updating the source text or the different source text using the generated textual content, wherein the source text or the different source text is stored in the reference database.

4. The method of claim 2, further comprising:
monitoring an event stream of an account associated with the user; and
responsive to determining that a change was made in the account based on the answer provided in the chat session, updating the source text or the different source text using the generated textual content.

5. The method of claim 2, further comprising:
monitoring the chat session to identify a function associated with the answer provided in the chat session;
monitoring an event stream of an account associated with the user to determine whether the identified function was called; and
responsive to determining that the identified function was called within a predetermined time, updating the source text or the different source text using the generated textual content.

6. The method of claim 2, wherein determining that the answer to the user query addresses the user query is based on an analysis of user sentiment during the chat session.

7. The method of claim 1, wherein the source text represents a first document stored in the reference database, and updating the corresponding source text or the different source text using the generated textual content comprises:
replacing at least a portion of the first document with the generated textual content or appending the generated textual content to the first document.

8. The method of claim 7, wherein the source text points to a second document stored in the reference database, and updating the corresponding source text or the different source text using the generated textual content comprises:
replacing at least a portion of the second document with the generated textual content or appending the generated textual content to the second document.

9. The method of claim 1, wherein the vector database stores a plurality of embeddings defining an embedding space and wherein identifying the synthetic question embedding comprises:
performing a vector similarity search operation within the embedding space to identify the synthetic question embedding, based on similarity measures between embeddings of the plurality of embeddings and the embedding representation of the user query.

10. The method of claim 1, wherein the vector database stores a plurality of synthetic question embeddings associating the plurality of synthetic question embeddings to corresponding source texts, the method further comprising:
generating a new synthetic question embedding based on the user query and the generated textual content; and
updating the vector database to include the new synthetic question embedding.

11. A computer system comprising:
a processing unit configured to execute computer-readable instructions to cause the system to:
responsive to receiving a user query in an ongoing chat session, obtain a source text from a reference database for augmenting a large language model (LLM) in generating a response that answers the user query, by searching a vector database to identify a synthetic question embedding, based on a similarity between the synthetic question embedding and an embedding representation of the user query, wherein the synthetic question embedding represents a synthetic question that is answerable using a corresponding source text and wherein a relevance of the identified synthetic question embedding is based on a similarity threshold;
responsive to determining that the searching does not return a relevant synthetic question embedding that meets the similarity threshold, monitor the ongoing chat session to detect an answer to the user query in a transcript of the chat session;
generate a prompt to the LLM for generating a textual content for inclusion in the reference database, the prompt including the user query and the transcript;
provide the prompt to the LLM to cause the LLM to generate the textual content; and
automatically update the corresponding source text or a different source text using the generated textual content.

12. The system of claim 11, wherein
the answer is provided by a human source other than a user.

13. The system of claim 12, wherein the processing unit is further configured to execute computer-readable instructions to cause the computer system to:
responsive to determining that the human source that provided the answer in the chat session is a trusted source, update the source text or the different source text using the generated textual content, wherein the source text or the different source text is stored in the reference database.

14. The system of claim 12, wherein the processing unit is further configured to execute computer-readable instructions to cause the computer system to:
monitor an event stream of an account associated with the user; and
responsive to determining that a change was made in the account based on the answer provided in the chat session, update the source text or the different source text using the generated textual content.

15. The system of claim 12, wherein the processing unit is further configured to execute computer-readable instructions to cause the computer system to:
monitor the chat session to identify a function associated with the answer provided in the chat session;
monitor an event stream of an account associated with the user to determine whether the identified function was called; and
responsive to determining that the identified function was called within a predetermined time, update the source text or the different source text using the generated textual content.

16. The system of claim 12, wherein the processing unit is further configured to execute computer-readable instructions to cause the computer system to determine that the answer to the user query addresses the user query based on an analysis of user sentiment during the chat session.

17. The system of claim 11, wherein the source text represents a first document stored in the reference database, and in updating the corresponding source text or the different source text using the generated textual content, the processing unit is further configured to execute computer-readable instructions to cause the computer system to:
replace at least a portion of the first document with the generated textual content or appending the generated textual content to the first document.

18. The system of claim 17, wherein the source text points to a second document stored in the reference database, and in updating the corresponding source text or the different source text using the generated textual content, the processing unit is further configured to execute computer-readable instructions to cause the computer system to:
replace at least a portion of the second document with the generated textual content or append the generated textual content to the second document.

19. The system of claim 11, wherein the vector database stores a plurality of embeddings defining an embedding space and wherein in identifying the synthetic question embedding, the processing unit is further configured to execute computer-readable instructions to cause the computer system to:
perform a vector similarity search operation within the embedding space to identify the synthetic question embedding, based on similarity measures between embeddings of the plurality of embeddings and the embedding representation of the user query.

20. A non-transitory computer-readable medium storing instructions that, when executed by a processing unit of a computing system, cause the computing system to:
responsive to receiving a user query in an ongoing chat session, obtain a source text from a reference database for augmenting a large language model (LLM) in generating a response that answers the user query, by searching a vector database to identify a synthetic question embedding, based on a similarity between the synthetic question embedding and an embedding representation of the user query, synthetic question and the query embedding, wherein the synthetic question embedding represents a synthetic question that is answerable using a corresponding source text and wherein a relevance of the identified synthetic question embedding is based on a similarity threshold;
responsive to determining that the searching does not return a relevant synthetic question embedding that meets the similarity threshold, monitor the ongoing chat session to detect an answer to the user query in a transcript of the chat session;
generate a prompt to the LLM for generating a textual content for inclusion in the reference database, the prompt including the user query and the transcript;
provide the prompt to the LLM to cause the LLM to generate the textual content; and
automatically update the corresponding source text or a different source text using the generated textual content.
